(19) United States
(12) Patent Application Publication
(10) Pub. No.: US 2024/0396185 A1
(43) Pub. Date: Nov. 28, 2024

(54) Cell, Battery and Electric Device

(71) Applicant: JIANGSU ZENERGY BATTERY TECHNOLOGIES CO., LTD., Suzhou City (CN)

(72) Inventors: Wenjie XU, Suzhou City (CN); Juntai LU, Suzhou City (CN); Zhigao LUO, Suzhou City (CN); Li SHI, Suzhou City (CN)

(21) Appl. No.: 18/673,169

(22) Filed: May 23, 2024

(30) Foreign Application Priority Data
May 23, 2023 (CN) 202321262097.4

(51) Int. Cl. H01M 50/54; H01M 10/0587; H01M 50/529; H01M 50/536

(52) U.S. Cl. CPC H01M 50/54; H01M 10/0587; H01M 50/536; H01M 50/529

(57) ABSTRACT

The disclosure relates to the field of battery technology, and provides a cell, a battery and an electric device. At least one end of the cell is provided with a tab group. The tab group includes a plurality of layers of tabs arranged sequentially outward from the center of the cell, and each layer of the plurality of layers of tabs surround the center of the cell. Each layer of the plurality of layers of tabs includes a plurality of sub-tabs, a slit is provided between two adjacent sub-tabs in each layer of the plurality of layers of tabs, and the slits in two adjacent layers of the plurality of layers of tabs are misaligned, which is conducive to the flattening of the tabs and makes the tabs less likely to wrinkle, and in turn will not easily lead to poor welding between the tabs and the connecting member.

### CROSS-REFERENCE TO RELATED APPLICATION

The disclosure claims the benefit of priority to Chinese Patent Application No. 202321262097.4, filed with the Chinese Patent Office on Mar. 23, 2023 and entitled “Cell, Battery and Electric Device”, which is incorporated in its entirety herein by reference.

### TECHNICAL FIELD

The disclosure relates to the field of battery technologies, and in particular, to a cell, a battery, and an electric device.

### BACKGROUND OF THE INVENTION

At present, full tab batteries all adopt tabs protruding from both ends. The tab shaping manner includes mechanical kneading as well as slit cutting followed by flattening. The traditional mechanical kneading is easy to generate metal scraps, after the tabs are flattened and compacted to cover the end surface of the cell, the density of the tabs is high, and the gaps between them are very small. As a result, the electrolyte has difficulty penetrating from the end surface of the cell to the inside of the cell. Consequently, this negatively impacts the electrolyte injection, infiltration, and wetting process. After slit cutting and flattening, the surface of the cell is even, and there is a gap between the tabs to allow for the flow of electrolyte. The slit cutting and flatting process is relatively beneficial to inject a liquid, and is currently applied by most enterprises.

In a design of tabs protruding from one or two ends of a cell, there are generally a plurality of layers of tabs, and the plurality of layers of tabs are prone to wrinkle after being flattened, thereby causing poor welding between the tabs and a connecting member.

### SUMMARY OF THE INVENTION

Some embodiments of the disclosure provide a cell, a battery and an electric device. The cell is conducive to the flattening of the tabs and makes the tabs less likely to wrinkle, and in turn will not easily lead to poor welding between the tabs and the connecting member.

Embodiments of the disclosure can be implemented as follows.

An embodiment of the disclosure provides a cell. At least one end of the cell is provided with a tab group. The tab group includes a plurality of layers of tabs sequentially arranged outward from the center of the cell, and each layer of the plurality of layers of tabs surrounds the center of the cell; each layer of the plurality of layers of tabs includes a plurality of sub-tabs, a slit is provided between two adjacent sub-tabs in each layer of the plurality of layers of tabs, and the slits in two adjacent layers of the plurality of layers of tabs are misaligned.

In an embodiment mode, edges of the same side of the plurality of layers of tabs are on the same straight line, a plurality of the sub-tabs in each layer of the plurality of layers of tabs has the same width, and the sub-tabs in two adjacent layers of the plurality of layers of tabs have different widths.

In an embodiment mode, edges on the same side of the plurality of layers of tabs are not on the same straight line, a plurality of the sub-tabs in each layer of the plurality of layers of tabs has the same width, and the sub-tabs in two adjacent layers of the plurality of layers of tabs have the same width.

In an embodiment mode, in two adjacent layers of the plurality of layers of tabs, the number of slits in the two adjacent layers of the plurality of layers of tabs is different.

In an embodiment mode, the width of each of the sub-tabs is 2-8 mm.

In an embodiment mode, the distance between the innermost tabs of the plurality of layers of tabs close to the center of the cell and the center of the cell is 1-3 mm.

In an embodiment mode, in a direction outward from the center of the cell, the height of the sub-tabs in the plurality of layers of tabs gradually increases.

In an embodiment mode, in a direction outward from the center of the cell, the height of the sub-tabs in a previous layer of the plurality of layers of tabs is smaller than the height of the sub-tabs in a next layer of the plurality of layers of tabs.

In an embodiment mode, in a direction outward from the center of the cell, the plurality of layers of tabs are divided into a plurality of groups in sequence, each group of the tabs at least includes two layers of plurality layers of the tabs, sub-tabs in each group of the tabs have the same height, and the height of the sub-tabs in the plurality of groups of the tabs are sequentially increased.

An embodiment of the disclosure further provides a battery including the cell above.

An embodiment of the disclosure further provides an electric device including the battery above.

The cell, the battery, and the electric device in the embodiments of the disclosure provide beneficial effects. For example, In order to flatten the tabs, the tab group is arranged as a plurality of layers of tabs arranged sequentially outward from the center of the cell, each layer of the plurality of layers of tabs includes a plurality of sub-tabs, a slit is provided between two adjacent sub-tabs in each layer of the plurality of layers of tabs, the slits in two adjacent layers of tabs are misaligned, and thus the slits between the plurality of layers of tabs can be prevented from being in the same straight line, which facilitates the flattening of the tabs, the plurality of layers of tabs are less likely to wrinkle after flattening, and in turn poor welding between the tabs and the connecting member is less likely to occur.

### BRIEF DESCRIPTION OF THE DRAWINGS

In order to illustrate technical solutions of embodiments of the disclosure more clearly, hereinafter, accompanying drawings requiring to be used in the embodiments will be briefly introduced. It should be understood that the following accompanying drawings only illustrate some embodiments of the disclosure, and therefore shall not be considered as limiting the scope. For a person of ordinary skill in the art, other related accompanying drawings may also be obtained according to these accompany drawings without any inventive effort.

FIG. 1 is a schematic structural diagram of a cell according to an embodiment of the disclosure;

FIG. 2 is a top view of a cell according to an embodiment of the disclosure;

FIG. 3 is a top view of a cell according to another alternative embodiment; and

FIG. 4 is a partial schematic structural diagram of an electrode plate according to an embodiment of the disclosure.

Reference signs: 100—cell; 110—tab group; 111—tab; 1111—sub-tab; 1112—slit; 120—electrode plate; 121—connection portion.

### DETAILED DESCRIPTION OF THE INVENTION

In order to make objects, technical solutions and advantages of the embodiments of the disclosure clearer, hereinafter, the technical solutions in the embodiments of the disclosure will be clearly and completely described with reference to the accompanying drawings in the embodiments of the disclosure. Obviously, the embodiments as described are only some rather than all the embodiments of the disclosure. Generally, components of the embodiments of the disclosure as described and illustrated in the accompanying drawings herein may be arranged and designed in various different configurations.

Therefore, the following detailed description of the embodiments of the disclosure provided in the accompanying drawings is not intended to limit the claimed scope of the disclosure, but merely represent selected embodiments of the disclosure. Based on the embodiments in the disclosure, all other embodiments obtained by a person of ordinary skill in the art without any inventive effort shall all belong to the scope of protection of the disclosure.

It should be noted that similar reference marks and letters represent similar items in the following accompanying drawings, and thus once a certain item is defined in one accompanying drawing, this item will not be further defined and explained in subsequent accompanying drawings.

In the illustration of the disclosure, it should be noted that orientation or positional relationships indicated by terms such as “upper”, “lower”, “inner”, and “outer” are orientation or positional relationships based on those as shown in the drawings or orientation or positional relationships which are conventionally used of the utility model product, and are only used to facilitate the illustration of the present invention and to simplify the illustration, rather than indicating or implying that a device or element referred to must have a specific orientation and be constructed and operated in the specific orientation, and therefore cannot be understood as limiting the disclosure.

In addition, the terms “first”, “second” and the like are configured for descriptive purposes only and cannot be considered as indicating or implying relative importance.

It is to be noted that the features in the embodiments can be combined with one another without conflicts.

The inventor of the disclosure found that, in a design in which tabs protrude from one end or two ends of a cell, there are generally a plurality of layers of tabs, and slits between two adjacent layers of the plurality of layers of tabs are located on the same straight line, so that the plurality of layers of tabs are likely to wrinkle after being flattened. The embodiments of the disclosure provide a cell, which is beneficial to the flattening of tabs, so that the tabs are less likely to wrinkle, and further poor welding between the tabs and the connecting member is less likely to occur.

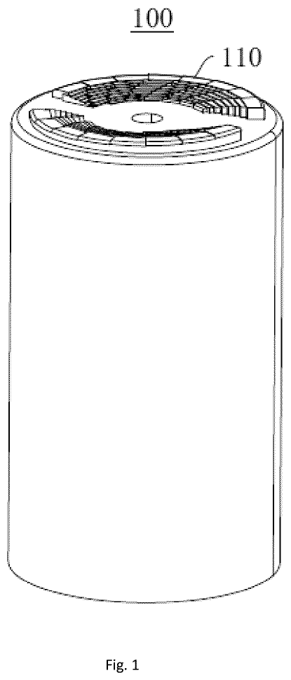

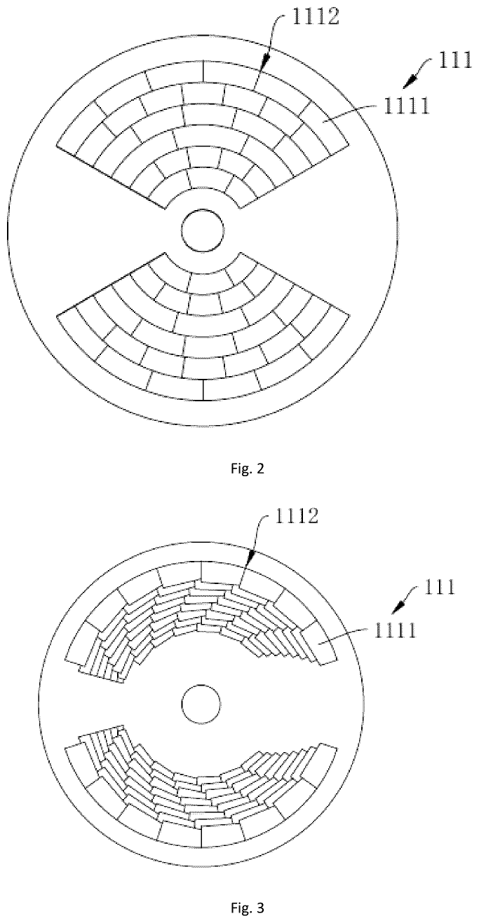

With reference to FIG. 1 to FIG. 3, an embodiment of the disclosure provides a cell 100, wherein at least one end of the cell 100 is provided with a tab group 110, the tab group 110 includes a plurality of layers of tabs 111 arranged sequentially outward from the center of the cell 100, and each layer of the plurality of layers of tabs 111 surrounds the center of the cell 100; each layer of the plurality of layers of tabs 111 includes a plurality of sub-tabs 1111, a slit 1112 is provided between two adjacent sub-tabs 1111 in each layer of the plurality of layers of tabs 111, and slits 1112 in two adjacent layers of the plurality of layers of tabs 111 are misaligned.

It should be noted that, the cell 100 provided in the embodiment of the disclosure is of a cylindrical shape, the plurality of sub-tabs 1111 in each layer of the plurality of layers of tabs 111 are arranged around the center of the cell 100, the slits 1112 are provided between two adjacent sub-tabs 1111 in each layer of the plurality of layers of tabs 111, and the slits 1112 in the two adjacent layers of the plurality of layers of tabs 111 are not collinear, so that the slits 1112 in the two adjacent layers of the plurality of layers of tabs 111 are misaligned.

The slits 1112 in the disclosure are different from the gaps formed between the two sub-tabs 1111 in the related art. The main difference is that the width of each of the slits 1112 in the disclosure is smaller, while the width of each of the gaps in the related art is larger. The disclosure does not form the sub-tabs 1111 by removing material, but by directly cutting, which allows for obtaining narrower slits 1112 with a smaller width. In contrast, the related art uses a conventional die-cutting process, which forms sub-tabs 1111 by removing material, resulting in a larger gap between the sub-tabs 1111. Therefore, the method of obtaining the slits 1112 in the disclosure is different from that in the related art, and the conventional die-cutting process cannot achieve the slits 1112 in the disclosure. Due to the very small width of the slits 1112 in the disclosure, the interval between the sub-tabs 1111 is not obvious.

In order to facilitate the flattening of the tabs 111, the tab group 110 is arranged as the plurality of layers of tabs 111 which are sequentially arranged outward from the center of the cell 100, each layer of the plurality of layers of tabs 111 includes a plurality of sub-tabs 1111, a slit 1112 is provided between two adjacent sub-tabs 1111 in each layer of the plurality of layers of tabs 111, and the slits 1112 in two adjacent layers of the plurality of layers of tabs 1111 are misaligned, so as to prevent the slits 1112 in the plurality of layers of tabs 111 from being in a straight line. This facilitates the flattening of the tabs 111, the plurality of layers of tabs 111 are less likely to wrinkle after being flattened, and thus poor welding between the tabs 111 and the connecting member is less likely to occur.

In an embodiment, edges at the same side of the plurality of layers of tabs 111 are on the same straight line, a plurality of sub-tabs 1111 in each layer of the plurality of layers of tabs 111 has the same width, and sub-tabs 1111 in two adjacent layers of the plurality of layers of tabs 111 have different widths.

It should be noted that, each layer of tabs 111 has two edges at two sides in a direction around the center of the cell 100, and edges at the same side of the plurality of layers of tabs 111 being on the same straight line means that the edges at one side of the plurality of layers of tabs 111 in a direction around the center of the cell 100 are on the same straight line, and the edges at the other side of the plurality of layers of tabs 111 in a direction around the center of the cell 100 are also on the same straight line. By defining that the plurality of sub-tabs 1111 in each layer of the plurality of layers of tabs 111 have the same width, and sub-tabs 1111 in two adjacent layers of the plurality of layers of tabs 111 have different widths, the purpose that slits 1112 in two adjacent layers of the plurality of layers of tabs 111 are misaligned is achieved.

In other embodiments, each layer of tabs 111 surrounds the center of the cell 100 at 360 degrees, that is, each layer of tab 111 does not have two opposite sides in a direction around the center of the cell 100. In this case, the slits 1112 in two adjacent layers of tabs 1111 are misaligned by controlling the width of the two adjacent layers of tabs 1111.

In an embodiment, edges at the same side of the plurality of layers of tabs 111 are not in the same straight line, a plurality of sub-tabs 1111 in each layer of the plurality of layers of tabs 111 has the same width, and sub-tabs 1111 in two adjacent layers of tabs 111 have the same width.

In this embodiment, the edges at one side of the plurality of layers of tabs 111 in a direction around the center of the cell 100 are not on the same straight line, and edges of the other side of the plurality of layers of tabs 111 in a direction around the center of the cell 100 are also not on the same straight line. By defining that the plurality of sub-tabs 1111 in each layer of the plurality of layers of tabs 111 have the same width, and the sub-tabs 1111 in two adjacent layers of tabs 111 have the same width, the purpose that slits 1112 in two adjacent layers of tabs 111 are misaligned is achieved.

In other embodiments, the plurality of sub-tabs 1111 in each layer of the plurality of layers of tabs 111 have different widths, and the sub-tabs 1111 in two adjacent layers of tabs 111 have the same or different widths, as long as the purpose that the slits 1112 in two adjacent layers of tabs 111 are misaligned can be achieved.

In an embodiment, the numbers of the slits 1112 in two adjacent layers of tabs 111 are different between two adjacent layers of tabs 111.

By controlling the numbers of the slits 1112 in two adjacent layers of tabs 111 to be different, the slits 1112 in two adjacent layers of tabs 111 can be prevented from being in a straight line, which facilitates flattening.

For example, the number of the slits 1112 in the plurality of layers of tabs 111 facing outward from the center of the cell 100 is respectively two, four, two, four, six, five, and so on. It can be understood that, the number of the layers of the tabs 111 and the number of the slits 1112 of each layer of the plurality of layers of tabs 111 are determined according to actual working conditions, as long as the purpose that the slits 1112 in two adjacent layers of tabs 111 are misaligned can be achieved.

In an embodiment, the width of each of the sub-tabs 1111 is 2-8 mm.

It has been verified that the 2-8 mm width of each of the sub-tabs 1111 is beneficial to flattening, and when the width is less than 2 mm, the tabs 111 can be easily inverted, and when the width is greater than 8 mm, the radius of curvature is large, and the tabs 111 easily bend; preferably, the width of each of the sub-tabs 1111 is 4-6 mm, and in order to control the width of each of the sub-tab 1111 to be between 4 mm and 6 mm as far as possible after the slits 1112 are cut, the width of each layer of the plurality of layers of tabs 111/(the number of the slits 1112 of the layer of the tabs 111+1)=4-6 mm should be set.

For example, the width of each of the sub-tabs 1111 is 2 mm, 4 mm, 6 mm, or 8 mm. Actually, the width of each of the sub-tabs 1111 may be selected within the foregoing range according to actual working conditions. When the width of each of the sub-tabs 1111 is in this range, the radius of curvature is small, and the sub-tabs 1111 are not easy to bend.

In an embodiment, the distance between the innermost tabs of the plurality of layers of tabs close to the center of the cell 100 and the center of the cell 100 is 1-3 mm.

It should be noted that the tabs 111 near the center of the cell 100 is the innermost tabs 111, and the distance between the innermost tabs 111 and the center of the cell 100 is 1-3 mm. If the distance between the innermost tabs 111 and the center of the cell 100 is less than 1 mm, there is a risk that the tabs 111 block the central hole of the cell 100, which is not conducive to subsequent ultrasonic torque welding or resistance welding. If the distance between the innermost tabs 1111 and the center of the cell 100 is greater than 3 mm, the number of layers of the tabs 111 is smaller, and the tabs 111 are less stacked, which is not conducive to welding.

For example, the distance between the innermost tabs 111 and the center of the cell 100 is 1 mm, 2 mm, or 3 mm, and the distance between the innermost tabs 111 and the center of the cell 100 may be determined according to actual working conditions in the foregoing range. In this range, the tabs 111 are less likely to block the center hole of the cell 100, the number of layers of the tabs 111 is larger, and there are more layers of tabs 111, which facilitates subsequent ultrasonic torque welding or resistance welding

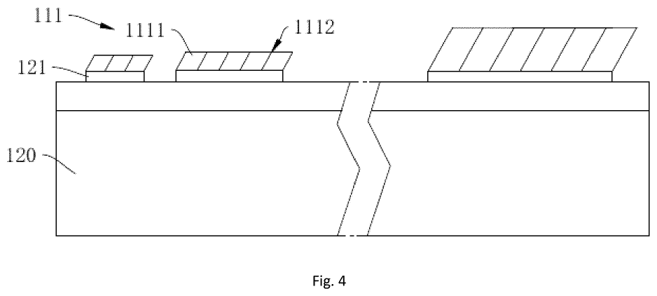

Referring to FIG. 4, in an embodiment, in a direction outward from the center of the cell 100, the height of sub-tabs 1111 in the plurality of layers of tabs 111 gradually increases.

It should be noted that, an electrode plate 120 and a separator are wound to form the cell 100, the tabs 111 protrude from one side of the electrode plate 120, and after the cell 100 is wound, in a direction outward from the center of the cell 100, the height of the sub-tabs 1111 in the plurality of layers of tabs 111 gradually increases; correspondingly, before the cell 100 is wound, in the length direction of the electrode plate 120, the height of the sub-tabs 1111 in the plurality of layers of tabs 111 gradually increases. A plurality of sub-tabs 1111 in each layer of the plurality of layers of tabs 111 has the same height.

A connection portion 121 is connected between the sub-tabs 1111 and the electrode plate 120. The connection portion 121 is rectangular, each of the sub-tabs 1111 is in a parallelogram shape, and the height of the sub-tabs 1111 refers to the height of the parallelogram shape of each of the sub-tabs 1111 in the height direction of the electrode plate 120.

By defining that the height of the sub-tabs 1111 in the plurality of layers of tabs 111 gradually increases in the direction outward from the center of the cell 100, that is, the sub-tabs 1111 in the inner tabs 111 are smaller in height, subsequently, the stacked compactness of the tabs 111 is larger, and thus the tabs 111 can be prevented from being flattened to the central hole of the cell 100, and it is also beneficial to welding and improves the overcurrent capability.

In an embodiment mode, in a direction outward from the center of the cell 100, the height of sub-tabs 1111 of a previous layer of tabs 111 is smaller than the height of sub-tabs 1111 of a next layer of tabs 111.

In this embodiment, the height of sub-tabs 1111 in two adjacent layers of tabs 111 are different, and the height of sub-tabs 1111 of a previous layer of tabs 111 is smaller than the height of sub-tabs 1111 in a next layer of tabs 111, which ensures that the overall height of the tabs 111 presents an increasing trend, and facilitates stacking of the thickness of the tabs 111.

In order to ensure that the tabs 111 do not fold over during a die cutting process, the height of the sub-tabs 1111 is set to be less than 8 mm. It is verified that when the height of the sub-tabs 1111 is greater than 8 mm, the fold-over proportion during the die cutting winding process of the tabs 111 is greater than or equal to 50%, which is not conducive to production. Preferably, the height of the sub-tabs 1111 is set to be 2-6 mm, and the fold-over proportion during the die cutting winding process of the tabs 111 can be controlled to be less than 1%.

For example, the height of the sub-tabs 1111 is 2 mm, 4 mm, or 6 mm, and the height of the sub-tabs 1111 can be determined within the foregoing range according to actual working conditions, as long as it can be ensured that the tabs 111 do not fold over during a die cutting process.

In an embodiment mode, in a direction outward from the center of the cell 100, a plurality of layers of tabs 111 are divided into a plurality of groups in sequence, each group of tabs 111 at least includes two layers of plurality layers of tabs 111, sub-tabs 1111 in each group of tabs 111 are of the same height, and the height of sub-tabs 1111 in a plurality of groups of tabs 111 increases in sequence.

In this embodiment, the sub-tabs 1111 in the same group of tabs 111 are of the same height. For example, the first twelve layers of tabs 111 form a group, the sub-tabs 1111 in the first twelve layers of tabs 111 are of the same height, the sub-tabs 111 in the thirteenth to twenty-second layers of tabs 111 form a group, the sub-tabs 1111 in the thirteenth to twenty-second layers of tabs 111 are of the same height, and the sub-tabs 111 behind the twenty-second layer of tabs 111 form a group, and the sub-tabs 1111 in the tabs 111 behind the twenty-second layer of tabs 111 are of the same height.

It can be understood that, the number of layers of the tabs 111 in each group of tabs 111 may be determined according to actual working conditions, for example, the first fifteen layers of tabs 111 are also form a group, and the sub-tabs 111 behind the fifteen layers of tabs 111 are form a group.

The cell 100 provided in the embodiments of the disclosure at least provides the following beneficial effects.

First, the slits 1112 in two adjacent layers of tabs 111 are misaligned, so that the slits 1112 in the plurality of layers of tabs 111 can be prevented from being on a straight line, which facilitates the flattening of tabs 111, and the plurality of layers of tabs 1111 are less likely to wrinkle after being flattened, and thus it is less likely to cause poor welding between the tabs 111 and the connecting member.

Secondly, by defining that the height of the sub-tabs 1111 in the plurality of layers of tabs 111 gradually increases in a direction outward from the center of the cell 100, that is, the sub-tabs 1111 in the inner tabs 111 have a smaller height, the stacked compactness of the tabs 111 subsequently increases, and the tabs 111 can be prevented from being flattened to the central hole of the cell 100, and it is also beneficial to welding and improves the overcurrent capability.

Thirdly, controlling the width of each of the sub-tabs 1111 to be 2-8 mm facilitates flattening.

Embodiments of the disclosure further provide a battery including the foregoing cell 100 and an electric device including the foregoing battery.

The electric device includes, but is not limited to, an automobile, a ship, and an aerospacecraft. The automobile can be a fuel automobile, a gas automobile or a new energy automobile. The new energy automobile can be a pure electric automobile, a hybrid automobile or an extended range automobile. The aerospacecraft includes aircraft, rockets, space shuttles, spacecraft, and the like. The embodiments of the disclosure do not specifically limit the described electric device.

In conclusion, the embodiments of the disclosure provide a cell 100, a battery, and an electric device. In order to facilitate the flattening of the tabs 111, the tab group 110 is arranged as a plurality of tabs 111 arranged outward sequentially from the center of the cell 100, and each layer of the plurality of layers of tabs 111 includes a plurality of sub-tabs 1111, a slit 1112 is provided between two adjacent sub-tabs 1111 in each layer of the plurality of layers of tabs 111, and the slits 1112 in two adjacent layers of tabs 111 are misaligned. This prevents the slits 1112 in the plurality of layers of tabs 111 from being in a straight line, and thus facilitates the flattening of the tabs 111. The plurality of layers of tabs 111 are less likely to wrinkle after being flattened, and thus poor welding between the tabs 111 and the connecting member is less likely to occur.

The foregoing descriptions are merely specific embodiments of the disclosure, but are not intended to limit the scope of protection of the disclosure. Any variation or replacement readily figured out by a person skilled in the art within the technical scope disclosed in the disclosure shall belong to the scope of protection of the disclosure. Therefore, the scope of protection of the disclosure shall be subject to the scope of protection of said claims.

1. A cell, wherein at least one end of the cell is provided with a tab group, the tab group comprises a plurality of layers of tabs arranged sequentially outward from the center of the cell, each layer of the plurality of layers of tabs surrounds the center of the cell; each layer of the plurality of layers of tabs comprises a plurality of sub-tabs, a slit is provided between two adjacent sub-tabs in each layer of the plurality of layers of tabs, and the slits in two adjacent layers of the plurality of layers of tabs are misaligned.

2. The cell according to claim 1, wherein edges of the same side of the plurality of layers of tabs are on the same straight line, a plurality of the sub-tabs in each layer of the plurality of layers of tabs have the same width, and the sub-tabs in two adjacent layers of the plurality of layers of tabs have different widths.

3. The cell according to claim 1, wherein edges of the same side of the plurality of layers of tabs are not on the same straight line, a plurality of the sub-tabs in each layer of the plurality of layers of tabs have the same width, and the sub-tabs in two adjacent layers of the plurality of layers of tabs have the same width.

4. The cell according to claim 1, wherein in two adjacent layers of the plurality of layers of tabs, the number of the slits in the two adjacent layers of the plurality of layers of tabs is different.

5. The cell according to claim 1, wherein the width of each of the sub-tabs is 2-8 mm.

6. The cell according to claim 1, wherein the distance between the innermost tabs of the plurality of layers of tabs close to the center of the cell and the center of the cell is 1-3 mm.

7. The cell according to claim 1, wherein in the direction outward from the center of the cell, the height of the sub-tabs in the plurality of layers of tabs gradually increases.

8. The cell according to claim 7, wherein in the direction outward from the center of the cell, the height of the sub-tabs in a previous layer of the plurality of layers of tabs is smaller than the height of the sub-tabs in a next layer of the plurality of layers of tabs.

9. The cell according to claim 7, wherein in the direction outward from the center of the cell, the plurality layers of the tabs are sequentially divided into a plurality of groups.

10. The cell according to claim 9, wherein each group of the tabs at least comprises two layers of plurality layers of the tabs.

11. The cell according to claim 9, wherein the sub-tabs in each group of the tabs have the same height.

12. The cell according to claim 9, wherein the height of the sub-tabs in a plurality of groups of the tabs are sequentially increased.

13. The cell according to claim 1, wherein each layer of tabs surrounds the center of the cell at 360 degrees.

14. The cell according to claim 1, wherein the cell comprises an electrode plate and a separator, the electrode plate and the separator are wound to form the cell, the before the cell is wound, in the length direction of the electrode plate, the height of the plurality of sub-tabs in the plurality of layers of tabs 111 gradually increases.

15. The cell according to claim 14, wherein the cell comprises a connection portion, the connection portion is connected between the plurality of sub-tabs and the electrode plate.

16. The cell according to claim 15, wherein the connection portion is rectangular, each of the plurality of sub-tabs is in a parallelogram shape.

17. An battery, comprising the cell according to claim 1.

18. The battery according to claim 17, wherein edges of the same side of the plurality of layers of tabs are on the same straight line, a plurality of the sub-tabs in each layer of the plurality of layers of tabs have the same width, and the sub-tabs in two adjacent layers of the plurality of layers of tabs have different widths.

19. The battery according to claim 17, wherein edges of the same side of the plurality of layers of tabs are not on the same straight line, a plurality of the sub-tabs in each layer of the plurality of layers of tabs have the same width, and the sub-tabs in two adjacent layers of the plurality of layers of tabs have the same width.

20. An electric device, comprising the battery according to claim 17.
